(19) United States
(12) Patent Application Publication
(10) Pub. No.: US 2014/0265683 A1
(43) Pub. Date: Sep. 18, 2014

(54) METHOD AND ARRANGEMENT FOR MOUNTING STATOR CORE IN HOUSING

(71) Applicant: REMY TECHNOLOGIES LLC, Pendleton, IN (US)

(72) Inventor: Noman Hossain, Fort Wayne, IN (US)

(73) Assignee: REMY TECHNOLOGIES LLC, Pendleton, IN (US)

(21) Appl. No.: 13/828,514

(22) Filed: Mar. 14, 2013

(51) Int. Cl. H02K 5/04

(52) U.S. Cl. CPC H02K 5/04
USPC 310/89

(57) ABSTRACT

An electric machine includes a plurality of windings, a stator core, and a housing. The stator core includes a substantially cylindrical outer surface with a plurality of protuberances extending from the outer surface. Each of the plurality of protuberances includes a flat side extending from the outer surface of the stator core in a radial direction and a rounded side opposite the flat side of the protuberance and extending from the outer surface of the stator core in the radial direction. The housing has a substantially cylindrical inner surface including a plurality of recesses configured to receive the plurality of protuberances on the outer surface of the stator core. Each of the plurality of recesses includes a flat side configured to engage the flat side of an associated protuberance and a round side having a contour matching the contour on the rounded side of the associated protuberance.

### FIELD

This disclosure relates to the field of electric machines, and particularly to stator cores for electric machines.

### BACKGROUND

Electric machines for vehicle starter motors typically include a rotor and a stator. The stator is held stationary during operation of the electric machine, while the rotor rotates within the stator. The stator includes a stator core with a plurality of windings retained within slots on the stator core. The stator core is fixedly secured to a housing. Typically, the stator core is secured to the housing with tight interference or friction fit such that the outer diameter surface of the stator core closely engages the inner diameter surface of the housing. The similar dimension of the stator core outer diameter and the housing inner diameter often makes insertion of the stator core into the housing difficult. In addition to an interference fit, the stator core may also be secured to the housing with other means, such as elongated bolts or other fasteners that extend through the housing and into the stator core. Once the electric machine is assembled with the stator core in the housing, the housing may be mounted in a vehicle or associated with some other electric machine application.

During operation of the electric machine, the stator core and housing encounter various stresses. For example, vibrations from a moving vehicle may loosen connections between the stator core and housing. Additionally, magnetic forces operating on the stator core during motor operation may further stress the coupling between the stator core and housing. For example, magnetic forces may urge the stator core to rotate relative to the housing. This may cause the bolt extending between the housing and the stator core to bow as rotation

In view of the foregoing, it would be advantageous to provide a stator core and housing arrangement with an improved coupling between the stator core and housing. It would also be advantageous if such improved coupling were relatively simple to implement and manufacture. Additionally, it would be advantageous if such improved coupling between the stator core and housing could be implemented and manufactured with little additional cost. Furthermore, it would be advantageous if such improved coupling provided additional benefits with respect to efficient operation of the electric machine.

### SUMMARY

In accordance with one exemplary embodiment of the disclosure, there is provided an electric machine comprising a plurality of windings, a stator core, and a housing. The stator core includes slots configured to retain the plurality of windings. The stator core also includes a substantially cylindrical outer surface with a plurality of protuberances extending from the outer surface. Each of the plurality of protuberances includes a flat side extending from the outer surface of the stator core in a radial direction and a rounded side opposite the flat side of the protuberance and extending from the outer surface of the stator core in the radial direction. The housing has a substantially cylindrical inner surface including a plurality of recesses configured to receive the plurality of protuberances on the outer surface of the stator core. Each of the plurality of recesses includes a flat side configured to engage the flat side of an associated protuberance and a round side having a contour matching the contour on the rounded side of the associated protuberance.

Pursuant to another exemplary embodiment of the disclosure, there is provided an electric machine comprising a stator core and a housing. The stator core includes slots configured to retain windings and a substantially cylindrical outer surface with a plurality of protuberances extending from the substantially cylindrical outer surface. The housing has a substantially cylindrical inner surface and a plurality of recesses. The stator core is positioned in the housing with the plurality of protuberances extending from the substantially cylindrical outer surface of the stator core positioned within the recesses of the housing. The substantially cylindrical inner surface of the housing is separated from the substantially cylindrical outer surface of the stator core such that the fluid channels are provided between the substantially cylindrical outer surface of the stator core and the substantially cylindrical inner surface of the housing.

In accordance with yet another exemplary embodiment of the disclosure, there is provided a method of assembling an electric machine. The method includes extrusion molding a housing tube and then cutting the housing tube to provide a plurality of housings, each of the plurality of housings including a substantially cylindrical inner surface. The method further includes aligning a plurality of protuberances of a stator core with a plurality of recesses of the housing, the plurality of recesses extending radially outward from the substantially cylindrical inner surface of the housing. In addition, the method includes inserting the stator core into each of the plurality of housings such that (i) a plurality of protuberances extending radially outward from a substantially cylindrical outer surface of the stator core are positioned in the plurality of recesses of the housing and (ii) the substantially cylindrical outer surface of the stator core is separated from the substantially cylindrical inner surface of the housing.

The above described features and advantages, as well as others, will become more readily apparent to those of ordinary skill in the art by reference to the following detailed description and accompanying drawings. While it would be desirable to provide a method and arrangement for mounting a stator core in a housing that provides one or more of the foregoing or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a cross-sectional view of an electric machine including a rotor, a stator core, windings, and a housing;

FIG. 2 shows a perspective view of the stator core and housing of the electric machine of FIG. 1 isolated from the rotor and windings;

FIG. 3 shows an enlarged perspective view of a protuberance of the stator core of FIG. 2 positioned in a recess of the housing;

FIG. 4 shows a perspective view of the stator core of FIG. 2 isolated from the housing;

FIG. 5 shows a perspective view of the housing of FIG. 2 isolated from the stator core;

FIG. 6 shows an enlarged perspective view of a recess in the housing of FIG. 2; and

FIG. 7 is a block diagram showing a method of manufacturing a stator core in a housing of an electric machine.

### DESCRIPTION

With reference to FIG. 1, an electric machine 10 comprises a rotor 12 and a stator 14 positioned within a housing 16. The rotor 12 is configured to rotate relative to the stator 14 and the housing 16 about an axis of rotation 18. The stator 14 includes a stator core 40 with a plurality of windings 20 positioned on the stator core. The stator core 40 is fixedly secured within the housing 16 with a plurality of ears 52 that extend from the stator core 40 and are received within recesses 72 in the housing 16. The arrangement of the stator core 40 within the housing 16 results in a plurality of fluid recesses between the stator core 40 and the housing 16.

With reference to FIGS. 2-4, the stator core 40 is a substantially cylindrical member. The stator core 40 is comprised of a ferromagnetic material, such as a steel or other iron based material. The ferromagnetic stator core 40 may be formed by a plurality of sheets of ferromagnetic material stacked together to form a lamination stack. A plurality of slots 42 are formed on an interior side 44 of the stator core 40. The slots 42 are configured to receive and retain the windings 20, as will be recognized by those of ordinary skill in the art. The windings 20 may be any of various types of windings such as lap windings or wave windings, and may be formed from segmented conductors or continuous lengths of wire.

The stator core 40 further includes a substantially cylindrical outer surface 50, which may also be referred to as the outer diameter surface. The substantially cylindrical outer surface 50 extends the entire length of the stator core 40, from one end to the opposite end. The substantially cylindrical outer surface 50 is generally smooth and continuous, but may include various irregularities. In the exemplary embodiment disclosed herein, a plurality of ears 52 or other protuberances extend radially outward from the substantially cylindrical outer surface 50.

The ears 52 are elongated and extend in the axial direction for the entire length of the stator core 40, from one end to the opposite end. In the exemplary embodiment of FIGS. 2-4 four ears 52 extend from the outer surface 50 of the stator core 40, with each ear 52 separated from an adjacent ear by 90 degrees. In other embodiments, a different number N of ears 52 may be included on the stator core 40, with each ear separated from an adjacent ear by N/360°. The ears 52 are non-symmetrical in shape with respect to a radial plane that intersects the ear and also passes through the axis 18 of the stator core 40.

With particular reference to FIGS. 3 and 4, each of the plurality of ears 52 includes a flat side 54, an outer side 58, and a rounded side 60. An axial hole 68 is included at a central location of each ear. The shape of the flat side 54 is different from the shape of the rounded side 60, and therefore the ears 52 are non-symmetrical in shape.

The flat side 54 extends from the outer surface 50 of the stator core in a radial direction. The flat side 54 is defined by at least one right angle 56 formed (i) between the flat side 54 and the outer surface 50 of the stator core 40 or (ii) between the flat side 54 and the outer side 58 of the ear 52. The surface of the ear 52 at the flat side 54 is generally smooth and flat and faces a circumferential direction. Opposing ears 52 have flat sides 54 that face the same circumferential direction. Two of the opposing ears 52a and 52c have flat sides 54 that face a clockwise direction (i.e., ears 52a and 52c are oriented such that a vector in the clockwise direction will pass through the flat side 54 of the ear 52 before passing through the rounded side 60 of the ear 52). Similarly, two of the opposing ears 52b and 52d have flat sides 54 that face a counter-clockwise direction (i.e., ears 52b and 52d are oriented such that a vector in the counter-clockwise direction will pass through the flat side 54 of the ear 52 before passing through the rounded side 60 of the ear 52).

The rounded side 60 of each ear 52 is opposite the flat side 54 of the ear and extends from the outer surface 50 of the stator core 40 in the radial direction. In the embodiment disclosed herein, the rounded side 60 is not a continuously curved surface, but instead includes two radiused corners with a flat portion extending between the radiused corners. In particular, the rounded side 60 includes a first radiused corner provided by a concave curved surface 62 extending between the rounded side and the outer surface 50 of the stator core 40. In addition, the rounded side 60 includes a second radiused corner provided by a convex curved surface 64 extending between the rounded side 60 and the outer side 58 of the ear 52. A transitional surface 66 is provided between the concave curved surface 62 and the convex curved surface 64. The transitional surface is generally flat and parallel to the surface provided on the flat side 54 of the ear 52.

The outer side 58 of the ear 52 extends between the flat side 54 of the ear 52 and the rounded side 60 of the ear 52. The outer side provides the outermost surface on the rotor core 40. The outer side 58 includes a surface that is generally perpendicular to the surface provided on the flat side 54 of the ear.

With reference now to FIGS. 5 and 6, the housing 16 includes a substantially cylindrical inner surface 70, which may also be referred to as the inner diameter surface. The substantially cylindrical inner surface 70 extends longer than the stator core 40 in the axial direction. Furthermore, the inner diameter of the housing 16 is greater than the outer diameter of the stator core 40, allowing the stator core 40 to fit completely within the housing 16. The substantially cylindrical inner surface 70 is generally smooth and continuous, but may include various irregularities. In the embodiment disclosed herein, a plurality of recesses 72 extend radially outward from the substantially cylindrical inner surface 70 of the housing 16. The recesses 72 correspond to the shape of the ears 52, and are configured to receive the ears 52 therein.

The recesses 72 are elongated and extend in an axial direction, as shown in FIGS. 5 and 6. In the exemplary embodiment disclosed herein, the recesses 72 do not extend the entire axial length of the housing 16. In this embodiment, a shelf 88 is provided at one axial end of the recess 72 and the opposite axial end of the recess is open. In particular, an opening 90 to the recess 72 is provided at a lip 92 at one end of the housing 16, allowing the ears 52 of the stator to be inserted into the recesses 72 through the openings 90. The length of the recess 72 in the axial direction between the opening 90 and the shelf 88 is sufficient to receive the entire ear 52 of the stator core 40 with the ear 52 abutting the shelf 88 at the end of the recess 72.

Each of the plurality of recesses 72 is defined by three walls (which may also be referred to herein as “sides” of the recess) on the housing 16 that extend in the axial direction and correspond the three surfaces of the ears 52. In particular, each recess 72 is defined within a flat wall 74, an outer wall 78, and a rounded wall 80 of the housing 16. The flat wall 74 of a given recess is configured to engage the flat side 54 of an associated ear 52 in an abutting fashion. The rounded wall 80 of a given recess includes a contour matching the contour on the rounded side 60 of the associated ear 52. Because the shape of the flat wall 74 is different from the shape of the rounded wall 80, the recesses 72 are non-symmetrical in shape.

The flat wall 74 of each recess 72 extends radially outward from the inner surface 70 of the housing 16. The flat wall 74 is defined by at least one right angle 76 formed (i) between the flat wall 74 and the inner surface 70 of the housing 16 or (ii) between the flat wall 74 and the outer wall 78 of the recess 72. The surface of the recess 72 at the flat wall 74 is generally smooth and flat and faces a circumferential direction. Opposing recesses 72 are defined by flat walls 54 that face the same circumferential direction. Two of the opposing recesses 72b and 72d have flat sides 74 that face a clockwise direction (i.e., recesses 72b and 72d are oriented such that a vector in the clockwise direction will pass through the flat side 74 of the recess 72 before passing through the rounded side 80 of the recess 72). Similarly, two of the opposing ears 72a and 72c have flat sides 74 that face a counter-clockwise direction (i.e., recesses 72a and 72c are oriented such that a vector in the counter-clockwise direction will pass through the flat side 74 of the recess 72 before passing through the rounded side 80 of the recess 72).

The rounded side 80 of each recess 72 is opposite the flat side 74 of the recess 72 and extends from the inner surface 70 of the housing 16 in the radial direction. The rounded side 80 includes a convex curved surface 82 extending between the rounded side 80 and the inner surface 70 of the housing 16. The rounded side 80 also includes a concave curved surface 84 extending between the rounded side 80 and the outer side 78 of the recess 72. A transitional surface 86 is provided between the convex curved surface 82 and the concave curved surface 84. The transitional surface is generally flat and parallel to the surface provided on the flat side 74 of the recess 72.

The outer side 78 of the recess 72 extends between the flat side 74 of the recess 72 and the rounded side 80 of the recess 72. The outer side 78 provides the outermost wall on the recess 72 of the housing 16. The outer side 78 includes a surface that is generally perpendicular to the surface provided on the flat side 74 of the recess 72.

With reference again to FIGS. 2 and 3, the stator core 40 is configured to be inserted into the housing 16. When the stator core 40 is inserted into the housing 16, each of the ears 52 on the stator core 40 is received into an associated recess 72 in the housing 16 with the flat side 54 of the ear 52 in an abutting relationship with the flat side 74 of the recess 72. Again, as shown in FIG. 2, opposing ears 52 have flat sides 54 that face the same circumferential direction (either clockwise or counter-clockwise). Adjacent ears (i.e., two consecutive ears 52 in the circumferential direction, which in the embodiment disclosed herein are separated by 90°) have flat sides 54 that face in opposite circumferential directions. The stator core 40 is inserted into the housing 16 until the ears 52 abut against the shelves 88 of the recesses 72. With the ears 52 in the position, opposing axial ends of the stator core 40 are fully received within the housing 16, and the axial ends of the housing 16 may be covered to enclose the stator core 40 within the housing. Bolts (not shown) may be inserted through the housing and into the axial holes 68 in the ears 52 to further secure the stator core 40 within the housing 16.

When the stator core 40 is properly seated in the housing 16, the ears 52 are positioned in the recesses 72, and a small gap 94 exists between the outer surface 50 of the stator core 40 and the inner surface 70 of the housing 16. This small gap 94 separates the outer surface 50 of the stator core 40 from the inner surface 70 of the housing 16 by approximately 1 mm to 20 mm in the radial direction, as represented by distance g in FIG. 2. The gap 94 extends around the entire circumference of the stator core 40 with the exception of the locations where the ears 52 are positioned in the recesses 72. Accordingly, the gap 94 results in four fluid channels 96a-96d that extend along the outer circumference 50 of the stator core 40 for the entire axial length of the stator core 40. Each fluid channel 96 is bounded between adjacent ears 52 on the stator core 42.

During operation of the electric machine 10, electric current flows through the windings 20, resulting in rotation of the rotor 12. Magnetic forces acting upon the stator core 40 in the circumferential direction force two of the flat sides 54 of the ears 52 against the flat walls 74 on the housing 16, depending on the direction of rotation of the electric machine. This abutment between the flat sides 54 of the ears 52 and flat walls 74 on the housing 16 prevents rotation of the stator core 40 relative to the housing 16. At the same time, fluid is moved through the fluid channels 96, thus cooling the stator core 40. This results in a cooler operating electric machine 10 and more efficient operation of the electric machine.

With reference now to FIG. 7, a method of manufacturing an electric machine 700 comprises extrusion molding a housing tube, as noted in step 702. The housing tube has a consistent cross-sectional shape. As shown in step 704, the housing tube is cut to form a plurality of housings 16. Next, in step 706, the inner cylindrical surface of each housing 16 is machined to form a plurality of recesses 72 in the inner cylindrical surface. The recesses 72 extend radially outward from the substantially cylindrical inner surface of the housing 16 and include a shelf 88, as shown in FIGS. 5 and 6. The cross-sectional shape of the recesses 72 is complimentary to the cross-sectional shape of the protuberances on the outer surface of the stator core. In step 708, the plurality of protuberances 52 of the stator core are aligned with the plurality of recesses 72 of the housing 16. Then, in step 710, the stator core 40 is moved in the axial direction and inserted into the housing 16 such that (i) the plurality of protuberances 52 extending radially outward from a substantially cylindrical outer surface 50 of the stator core 40 are positioned in the plurality of recesses 72 of the housing 16 and (ii) the substantially cylindrical outer surface 50 of the stator core 40 is separated from the substantially cylindrical inner surface 70 of the housing 16. When the stator core 40 is thus positioned in the housing 16, the flat side 54 of each of the plurality of protuberances 52 are in abutment with a flat wall 74 of the stator housing 16. The separation between the substantially cylindrical outer surface 50 of the stator core 40 and the housing 40 forms voids that provide a plurality of fluid channels 96. During operation of the electric machine, fluid is forced through the fluid channels to cool the stator.

The foregoing detailed description of one or more embodiments of the method and arrangement for mounting a stator core in a housing has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. An electric machine comprising:
a plurality of windings;
a stator core including slots configured to retain the plurality of windings, the stator core including a substantially cylindrical outer surface with a plurality of protuberances extending from the outer surface, each of the plurality of protuberances including a flat side extending from the outer surface of the stator core in a radial direction and a rounded side opposite the flat side of the protuberance and extending from the outer surface of the stator core in the radial direction;
a housing with a substantially cylindrical inner surface, the inner surface including a plurality of recesses configured to receive the plurality of protuberances on the outer surface of the stator core, each of the plurality of recesses including a flat side configured to engage the flat side of an associated protuberance and a round side having a contour matching the contour on the rounded side of the associated protuberance.

2. The electric machine of claim 1 wherein the flat side of the protuberance is defined by at least one right angle formed between the flat side and the outer surface of the stator core or the an outer side of the protuberance extending between the flat side and the rounded side.

3. The electric machine of claim 2 wherein the rounded side of the protuberance is defined by at least one of a concave curved surface extending between the rounded side and the outer surface of the stator core or a convex curved surface extending between the rounded side and the outer side of the protuberance.

4. The electric machine of claim 1 wherein the plurality of protuberances include at least two protuberances.

5. The electric machine of claim 1 wherein the plurality of protuberances include at least four protuberances, including two protuberances having flat sides facing a clockwise direction and two protuberances having flat sides facing a counter-clockwise direction.

6. The electric machine of claim 5 wherein the two protuberances having flat sides facing the clockwise direction extend directly opposite one another in the radial direction, and the two protuberances having flat sides facing the counter-clockwise direction extend directly opposite one another in the radial direction.

7. The electric machine of claim 1 wherein the substantially cylindrical outer surface of the stator core is separated from the substantially cylindrical inner surface of the housing by a gap extending between the protuberances.

8. The electric machine of claim 1 wherein each of the protuberances includes a hole configured to receive an elongated fastener.

9. The electric machine of claim 1 wherein each of the plurality of recesses is an axial recess extending from a first end of the housing.

10. The electric machine of claim 9 wherein the each of the plurality of recesses defines a shelf configured to abut the associated protuberance.

11. The electric machine of claim 9 wherein the housing is an extruded housing.

12. An electric machine comprising:
a stator core including slots configured to retain windings, the stator core including a substantially cylindrical outer surface with a plurality of protuberances extending from the substantially cylindrical outer surface; and
a housing with a substantially cylindrical inner surface and a plurality of recesses, the stator core positioned in the housing with the plurality of protuberances extending from the substantially cylindrical outer surface of the stator core positioned within the recesses of the housing, the substantially cylindrical inner surface of the housing separated from the substantially cylindrical outer surface of the stator core such that the fluid channels are provided between the substantially cylindrical outer surface of the stator core and the substantially cylindrical inner surface of the housing.

13. The electric machine of claim 12 wherein the fluid channels extend in an axial direction for an entire length of the stator core.

14. The electric machine of claim 13 wherein the fluid channels extend in a circumferential direction an entire distance between two of the plurality of protuberances.

15. The electric machine of claim 12 wherein the substantially cylindrical inner surface of the housing is separated from the substantially cylindrical outer surface of the stator core by at least 2 mm.

16. The electric machine of claim 12 wherein each of the plurality of protuberances includes a flat side extending from the substantially cylindrical outer surface of the stator core in a radial direction and a rounded side opposite the flat side of the protuberance and extending from the substantially cylindrical outer surface of the stator core in the radial direction.

17. A method of assembling an electric machine comprising:
extrusion molding a housing tube;
cutting the housing tube to provide a plurality of housings, each of the plurality of housings including a substantially cylindrical inner surface;
aligning a plurality of protuberances of a stator core with a plurality of recesses of the housing, the plurality of recesses extending radially outward from the substantially cylindrical inner surface of the housing;
inserting the stator core into each of the plurality of housings such that (i) a plurality of protuberances extending radially outward from a substantially cylindrical outer surface of the stator core are positioned in the plurality of recesses of the housing and (ii) the substantially cylindrical outer surface of the stator core is separated from the substantially cylindrical inner surface of the housing.

18. The method of claim 17 further comprising machining the substantially cylindrical inner surface of the housing to form the recesses prior to aligning the plurality of protuberances of the stator core with the recesses.

19. The method of claim 17 wherein inserting the stator core into each of the plurality of housings includes bringing a flat side of each of the plurality of protuberances into abutment with the stator housing.

20. The method of claim 17 further comprising inserting fluid into voids provided between the substantially cylindrical outer surface of the stator core and the substantially cylindrical inner surface of the housing.
